(19) United States
(12) Patent Application Publication
(10) Pub. No.: US 2011/0125982 A1
(43) Pub. Date: May 26, 2011

(54) MEMORY DEVICE, MEMORY SYSTEM HAVING THE SAME, AND METHOD OF CONTROLLING THE MEMORY DEVICE

(76) Inventors: Jang-Seok Choi, Seoul (KR); Dong-Yang Lee, Yongin-si (KR); Joon Kun Kim, Yongin-si (KR)

(21) Appl. No.: 12/909,031

(22) Filed: Oct. 21, 2010

(30) Foreign Application Priority Data
Nov. 24, 2009 (KR) 10-2009-0114124

(51) Int. Cl. G06F 12/06

(52) U.S. Cl. 711/200; 711/E12.078

(57) ABSTRACT

A memory controller includes a memory capacity setting circuit and an address selecting circuit. The memory capacity setting circuit is configured to set a valid memory capacity of a memory device based on a defective cell information signal, and generate a valid memory capacity signal based on the valid memory capacity. The address selecting circuit is configured to disable an address signal corresponding to a memory block having a defective cell, and generate a selection address signal based on the valid memory capacity signal and the disabled address signal. A non-defective cell in a memory cell array is activated based on the selection address signal and a command signal.

### CROSS-REFERENCE TO RELATED APPLICATIONS

This application claims priority under 35 U.S.C. §119 to Korean Patent Application No. 10-2009-0114124, filed on Nov. 24, 2009, the disclosure of which is incorporated by reference herein in its entirety.

### BACKGROUND

1. Technical Field

Exemplary embodiments of the present inventive concept relate to a memory device, a memory system having the memory device, and a method of controlling the memory device.

2. Discussion of the Related Art

The capacity and operating speeds of semiconductor memory devices such as, for example, dynamic random access memory devices (DRAMs), have been increasing. The total capacity of a semiconductor memory device may be increased by decreasing the size of memory cells included in the semiconductor memory device, or by increasing the chip size of the semiconductor memory device. However, the presence of defective cells in a semiconductor memory device may prevent the capacity of the device from being increased, and may further result in the device being discarded during production.

Therefore, a need exists for a system and method for increasing the production yield of semiconductor memory devices by utilizing semiconductor memory devices that include defective cells.

### SUMMARY

According to an exemplary embodiment, a memory controller includes a memory capacity setting circuit and an address selecting circuit. The memory capacity setting circuit is configured to set a valid memory capacity of a memory device based on a defective cell information signal, and generate a valid memory capacity signal based on the memory capacity. The address selecting circuit is configured to disable an address signal corresponding to a memory block having a defective cell, and generate a selection address signal based on the valid memory capacity signal and the disabled address signal. A non-defective cell in a memory cell array is activated based on the selection address signal and a command signal.

In an exemplary embodiment, the valid memory capacity includes one of a first capacity corresponding to a full capacity of the memory device or a second capacity corresponding to half of the full capacity of the memory device.

In an exemplary embodiment, a capacity of the memory device is set to the first capacity upon determining that a defective cell is not included in the memory device, and set to the second capacity upon determining that the defective cell is included in the memory device.

In an exemplary embodiment, a memory block having a defective cell in the memory cell array is not activated during a refresh mode of the memory device.

In an exemplary embodiment, a non-volatile memory device configured to store the defective cell information signal and provide the defective cell information signal to the memory controller in response to a request from the memory controller.

In an exemplary embodiment, the memory device includes an internal register configured to store the defective cell information signal, and disable the address signal corresponding to the memory block having the defective cell, based on the defective cell information signal.

In an exemplary embodiment, the memory device comprises a stacked memory device having a plurality of stacked semiconductor memory chips.

In an exemplary embodiment, one of the plurality of stacked semiconductor memory chips has a defective cell, and a capacity of the one of the plurality of stacked semiconductor chips is set to half of a capacity of a stacked semiconductor memory chip not having the defective cell.

In an exemplary embodiment, a most significant bit (MSB) of a row address corresponding to a semiconductor memory chip having a defective cell is not used in the selection address signal.

According to an exemplary embodiment, a stacked memory device includes at least one master chip and at least one slave chip. The at least one master chip is configured to interface with an exterior of a memory device, and disable an address signal corresponding to a memory block that includes a defective cell. The at least one slave chip is stacked on the master chip, and electrically coupled to the master chip via a through-electrode.

In an exemplary embodiment, the stacked memory device receives a defective cell information signal from a memory controller.

In an exemplary embodiment, the stacked memory device is configured to disable the address signal corresponding to the memory block that includes the defective cell upon the memory controller setting a valid memory capacity of the stacked memory device, wherein the memory controller sets the valid memory capacity based on the defective cell information signal.

In an exemplary embodiment, the valid memory capacity includes one of a first capacity corresponding to a full capacity of the stacked memory device or a second capacity corresponding to half of the full capacity of the stacked memory device.

In an exemplary embodiment, a capacity of a first slave chip is set to the first capacity upon determining that the first slave chip does not include a defective cell, and a capacity of a second slave chip is set to the second capacity upon determining that the second slave chip includes the defective cell.

According to an exemplary embodiment, a memory system includes a memory controller and a memory module. The memory controller includes a memory capacity setting circuit and an address selecting circuit. The memory capacity setting circuit is configured to set a valid memory capacity of a memory device based on a defective cell information signal, and generate a valid memory capacity signal based on the valid memory capacity. The address selecting circuit is configured to disable an address signal corresponding to a memory block having a defective cell, and generate a selection address signal based on the valid memory capacity signal and the disabled address signal. The memory module includes a plurality of memory devices, and each of the plurality of memory devices is configured to activate a non-defective cell in a memory cell array in each of the plurality of memory devices based on the selection address signal and a command signal.

In an exemplary embodiment, the memory module includes a serial presence detector (SPD) configured to store the defective cell information signal and provide the defective cell information signal to the memory controller in response to a request from the memory controller.

In an exemplary embodiment, the SPD is configured to store information relating to the memory module.

In an exemplary embodiment, the information stored in the SPD includes a mounting status, an operating speed, or an operating time of a memory device.

In an exemplary embodiment, the valid memory capacity includes one of a first capacity corresponding to a full capacity of the memory device or a second capacity corresponding to half of the full capacity of the memory device.

According to an exemplary embodiment, a method of controlling a memory device includes setting a valid memory capacity of the memory device based on a defective cell information signal, generating a valid memory capacity signal based on the valid memory capacity, disabling an address signal corresponding to a memory block having a defective cell, generating a selection address signal based on the valid memory capacity signal and the disabled address signal, and activating a non-defective cell in a memory cell array based on the selection address signal and a command signal.

### BRIEF DESCRIPTION OF THE DRAWINGS

The above and other features of the present inventive concept will become more apparent by describing in detail exemplary embodiments thereof with reference to the accompanying drawings in which:

FIG. 1 is a block diagram illustrating a memory system, according to an exemplary embodiment.

FIG. 2 is a cross-sectional view illustrating a stacked memory device included in the memory system of FIG. 1, according to an exemplary embodiment.

FIG. 3 is a perspective view illustrating the stacked memory device shown in FIG. 2, according to an exemplary embodiment.

FIG. 4 is a block diagram illustrating a memory system, according to an exemplary embodiment.

FIG. 5 is a table illustrating an address structure of a stacked memory device based on memory capacity, according to an exemplary embodiment.

FIGS. 6A-8D are cross-sectional views illustrating the stacked memory device included in the memory system shown in FIGS. 1 and 4, according to an exemplary embodiment.

FIG. 9 is a block diagram illustrating a memory system, according to an exemplary embodiment.

FIG. 10 is a plan view illustrating a memory module included in the memory system of FIG. 9, according to an exemplary embodiment.

FIG. 11 is a cross-sectional view illustrating a memory module included in the memory system of FIG. 9, according to an exemplary embodiment.

FIG. 12 is a plan view illustrating a memory module included in the memory system of FIG. 9, according to an exemplary embodiment.

FIG. 13 is a plan view illustrating a memory module included in the memory system of FIG. 9, according to an exemplary embodiment.

FIG. 14 is a flowchart illustrating a method of controlling a memory system, according to an exemplary embodiment.

FIG. 15 is a flowchart illustrating a process for manufacturing and shipping a memory module including a stacked memory device, according to an exemplary embodiment.

### DETAILED DESCRIPTION OF EXEMPLARY EMBODIMENTS

Exemplary embodiments of the present inventive concept will be described more fully hereinafter with reference to the accompanying drawings. Like reference numerals refer to like elements throughout the accompanying drawings. The inventive concept may, however, be embodied in many different forms and should not be construed as limited to the exemplary embodiments set forth herein.

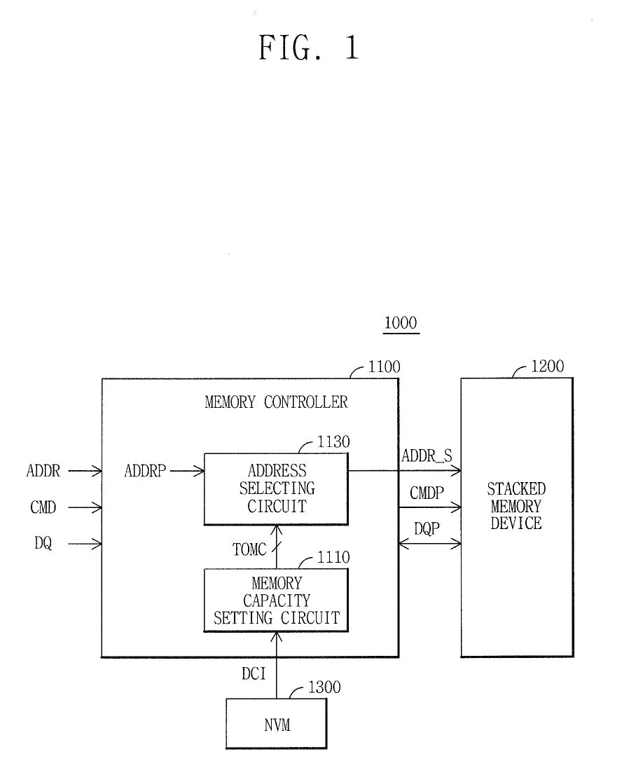

FIG. 1 is a block diagram illustrating a memory system 1000, according to an exemplary embodiment.

Referring to FIG. 1, the memory system 1000 includes a memory controller 1100, a stacked memory device 1200 and a non-volatile memory device 1300.

The non-volatile memory device 1300 stores a defective cell information signal DCI and provides the defective cell information signal DCI to the memory controller 1100 in response to a request from the memory controller 1100. The memory controller 1100 performs signal processing such as, for example, channel-skew compensation and buffering with respect to a first address signal ADDR, a first command signal CMD and a first data signal DQ. Further, the memory controller 1100 generates a second address signal ADDRP, a second command signal CMDP and a second data signal DQP.

The memory controller 1100 receives the defective cell information signal DCI, sets a valid memory capacity of each memory chip in the stacked memory device 1200 based on the defective cell information signal DCI, and generates a valid memory capacity signal TOMC. The memory controller 1100 generates a selection address signal ADDR_S based on the second address signal ADDRP and the valid memory capacity signal TOMC. When generating the selection address signal ADDR_S, the memory controller 1100 disables the address signals corresponding to memory blocks having defective cells. The memory controller 1100 provides the selection address signal ADDR_S, the second command signal CMDP and the second data signal DQP to the stacked memory device 1200, and receives data from the stacked memory device 1200.

A memory cell array in the stacked memory device 1200 is activated based on the selection address signal ADDR_S and the second command signal CMDP. Since addresses corresponding to memory blocks having defective cells are disabled when the selection address signal ADDR_S is generated, memory blocks in the memory cell array having defective cells are not activated.

The memory controller 1100 includes a memory capacity setting circuit 1110 and an address selecting circuit 1130. The memory capacity setting circuit 1110 sets the valid memory capacity of each memory chip in the stacked memory device 1200 based on the defective cell information signal DCI, and generates the valid memory capacity signal TOMC. The address selecting circuit 1130 disables the address signals corresponding to memory blocks that include a defective cell and generates the selection address signal ADDR_S based on the valid memory capacity signal TOMC.

Hereinafter, the operation of the memory system 1000 of FIG. 1 will be described.

Since addresses corresponding to memory blocks having defective cells are disabled when the selection address signal ADDR_S is generated, the memory system 1000 does not access memory blocks having defective cells in memory cell arrays included in semiconductor memory chips in the stacked memory device 1200. The memory controller 1100 sets a valid memory capacity of each of the semiconductor memory chips in the stacked memory device 1200 based on the defective cell information signal DCI.

The defective cell information signal DCI may include a signal resulting from testing the stacked memory device 1200 after fabricating the stacked memory device 1200, or a signal resulting from testing the stacked memory device 1200 after fabricating a memory module using a plurality of stacked memory devices. The defective cell information signal DCI is stored in the non-volatile memory device 1300 after the stacked memory device 1200 is tested. When the stacked memory device 1200 is tested, semiconductor memory devices having similar addresses corresponding to defective cells among semiconductor memory chips included in the stacked memory device 1200 may be classified.

The memory controller 1100 receives the defective cell information signal DCI from the non-volatile memory device 1300 before accessing the stacked memory device 1200, and sets a valid memory capacity of each semiconductor memory chip in the stacked memory device 1200. For example, the valid memory capacity may include a first capacity corresponding to the target capacity when the stacked memory device 1200 was first designed (e.g., full capacity), or a second capacity corresponding to half of the target capacity. For example, the first capacity may be 2 GB and the second capacity may be 1 GB.

A memory block having defective cells is not activated during operation modes (e.g., an auto refresh mode or a self-refresh mode) of a semiconductor memory device.

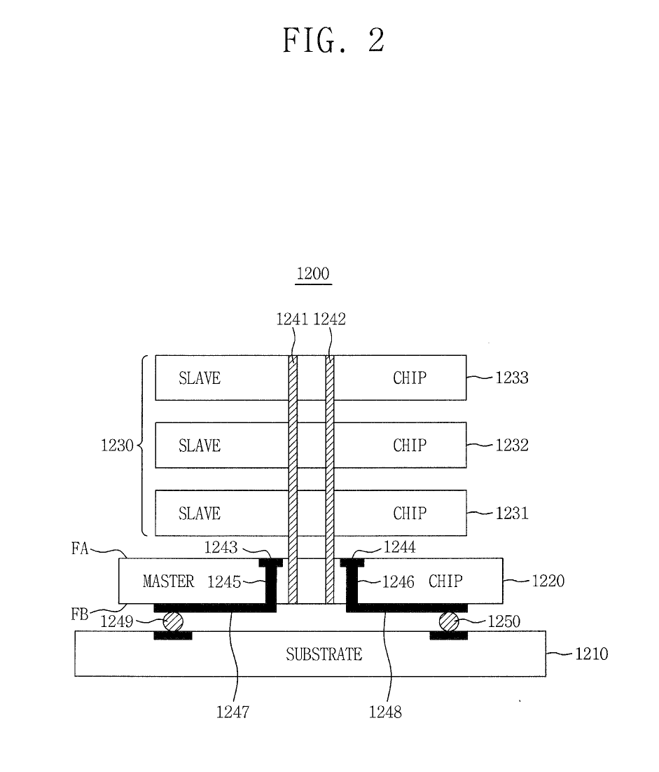

FIG. 2 is a cross-sectional view illustrating a stacked memory device 1200 included in the memory system of FIG. 1, according to an exemplary embodiment.

Referring to FIG. 2, the stacked memory device 1200 may include a master chip 1220 and a plurality of slave chips 1230. Although the stacked memory device 1200 shown in FIG. 2 includes three slave chips 1231, 1232 and 1233 electrically coupled to the master chip 1220, the present inventive concept is not limited thereto. The master chip 1220 includes a first input/output circuit and a first memory core for interfacing with an exterior of a memory device. Each of the slave chips 1231, 1232 and 1233 is stacked on the master chip 1220 and includes a second memory core. Further, each of the slave chips 1231, 1232 and 1233 is electrically coupled to each other and to the master chip 1220 via through-electrodes 1241 and 1242.

The stacked memory device 1200 transmits and receives data and control signals via the through-electrodes 1241 and 1242. Further, the stacked memory device 1200 may include a substrate 1210 electrically connected to the master chip 1220.

The stacked memory device 1200 may further include internal electrodes 1243 and 1244, through-electrodes 1245 and 1246, and internal electrodes 1247 and 1248.

The internal electrodes 1243 and 1244 are formed on a first surface FA of the master chip 1220. The through-electrodes 1245 and 1246 electrically connect the first surface FA of the master chip 1220 and a second surface FB of the master chip 1220. Each of the internal electrodes 1247 and 1248 is formed on the second surface FB of the master chip 1220 and is electrically connected to each of the internal electrodes 1243 and 1244. External terminals 1249 and 1250 connect the internal electrodes 1247 and 1248 to the substrate 1210. In an embodiment, through-electrodes may include a through-silicon-via (TSV).

Each of the plurality of slave chips 1230 may include a memory cell array and basic circuits such as, for example, a sense amplifier or a decoder. The master chip 1220 may further include a circuit for controlling the plurality of slave chips 1230, including the memory cell arrays and the basic circuits. The master chip 1220 and the slave chips 1230 may have a similar structure, or the master chip 1220 may not include a memory cell array.

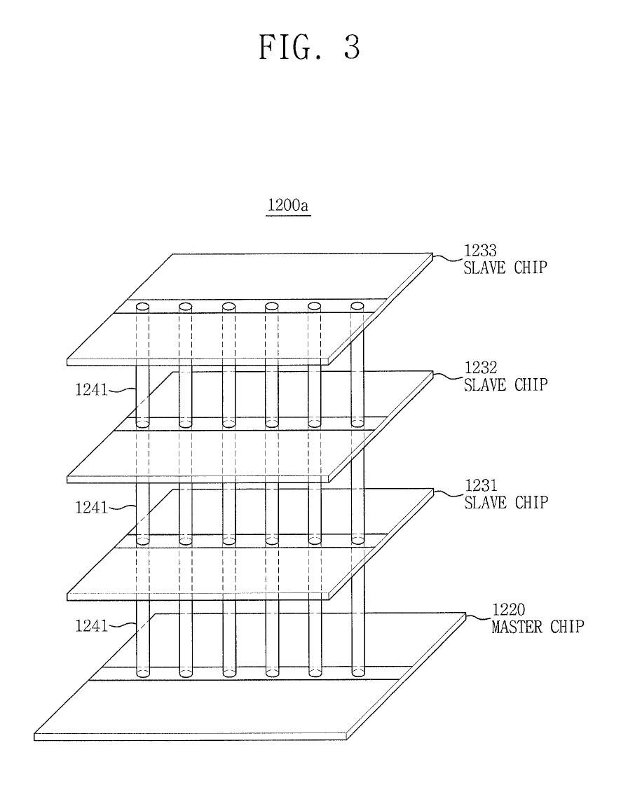

FIG. 3 is a perspective view illustrating the stacked memory device 1200 shown in FIG. 2, according to an exemplary embodiment.

Referring to FIG. 3, a stacked memory device 1200a includes a master chip 1220 and slave chips 1231, 1232 and 1233 electrically connected to each other via through-electrodes 1241. Although the through-electrodes 1241 are arranged in one row in FIG. 3, arrangement of the through-electrodes 1241 is not limited thereto. For example, the through-electrodes 1241 may be arranged in two or more rows.

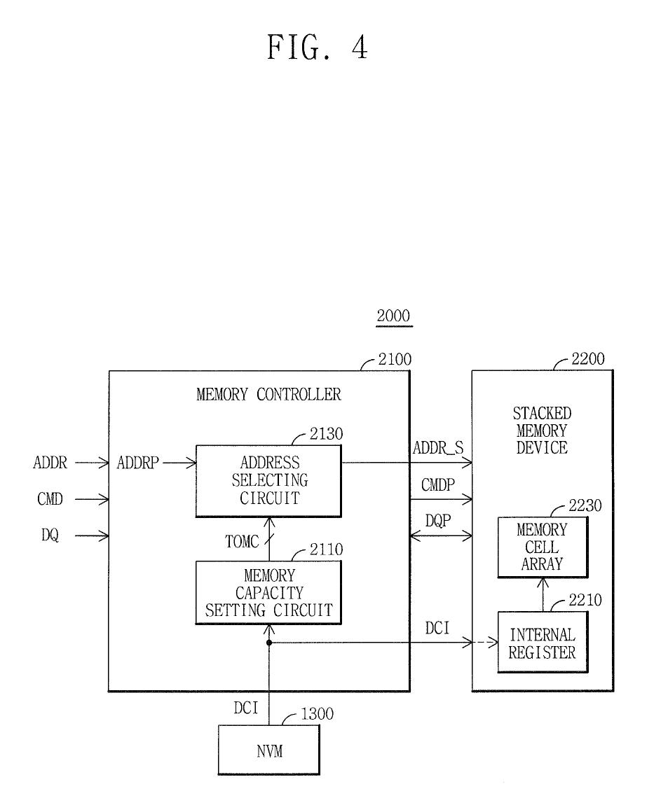

FIG. 4 is a block diagram illustrating a memory system 2000, according to an exemplary embodiment.

Referring to FIG. 4, the memory system 2000 includes a memory controller 2100, a stacked memory device 2200 and a non-volatile memory device 1300.

The non-volatile memory device 1300 stores a defective cell information signal DCI and provides the defective cell information signal DCI to the memory controller 2100 in response to a request from the memory controller 2100. The memory controller 2100 performs signal processing such as, for example, channel-skew compensation and buffering with respect to a first address signal ADDR, a first command signal CMD and a first data signal DQ. The memory controller 2100 further generates a second address signal ADDRP, a second command signal CMDP and a second data signal DQP. Further, the memory controller 2100 provides the defective cell information signal DCI to the stacked memory device 2200.

The memory controller 2100 receives the defective cell information signal DCI, sets a valid memory capacity of each memory chip in the stacked memory device 220 based on the defective cell information signal DCI, and generates a valid memory capacity signal TOMC. The memory controller 2100 generates a selection address signal ADDR_S based on the second address signal ADDRP and the valid memory capacity signal TOMC. When generating the selection address signal ADDR_S, the memory controller 2100 disables the address signals corresponding to memory blocks having defective cells. The memory controller 2100 provides the selection address signal ADDR_S, the second command signal CMDP and the second data signal DQP to the stacked memory device 2200, and receives data from the stacked memory device 2200.

A memory cell array in the stacked memory device 2200 is activated based on the selection address signal ADDR_S and the second command signal CMDP. Since addresses corresponding to memory blocks having defective cells are disabled when the selection address signal ADDR_S is generated, memory blocks in the memory cell array having defective cells are not activated.

The stacked memory device 2200 includes an internal register 2210 and a memory cell array 2230. When the memory controller 2100 accesses the memory cell array 2230, the internal register 2210 stores the defective cell information signal DCI, and disables address signals corresponding to memory blocks having defective cells based on the defective cell information signal DCI.

The memory controller 2100 includes a memory capacity setting circuit 2110 and an address selecting circuit 2130. The memory capacity setting circuit 2110 sets the valid memory capacity for each memory chip in the stacked memory device 2200 based on the defective cell information signal DCI, and generates the valid memory capacity signal TOMC. The address selecting circuit 2130 disables the address signals corresponding to memory blocks that include a defective cell and generates the selection address signal ADDR_S based on the valid memory capacity signal TOMC.

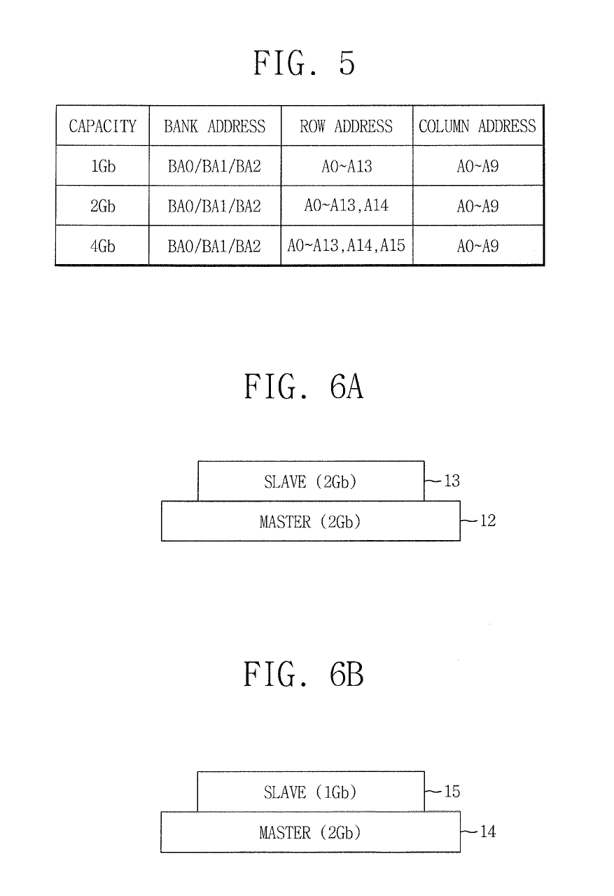

FIG. 5 is a table illustrating an address structure of a stacked memory device based on memory capacity, according to an exemplary embodiment.

Referring to FIG. 5, semiconductor memory devices having memory capacities of 1 GB, 2 GB and 3 GB may have the same bank and column addresses. However, the most significant bits (MSBs) of the row addresses of the different memory capacities may be different. For example, a most significant bit (MSB) of a row address corresponding to a semiconductor memory chip in the stacked memory device having a defective cell is not used when generating the selection address signal. As a result, a semiconductor memory chip in the stacked memory device having a defective cell may have half of the capacity of a semiconductor memory chip not having a defective cell.

For example, when the memory capacity of a memory chip having no defective cells is 2 GB (e.g., full capacity), the memory capacity of a memory chip having a defective cell may be 1 GB (e.g., half capacity).

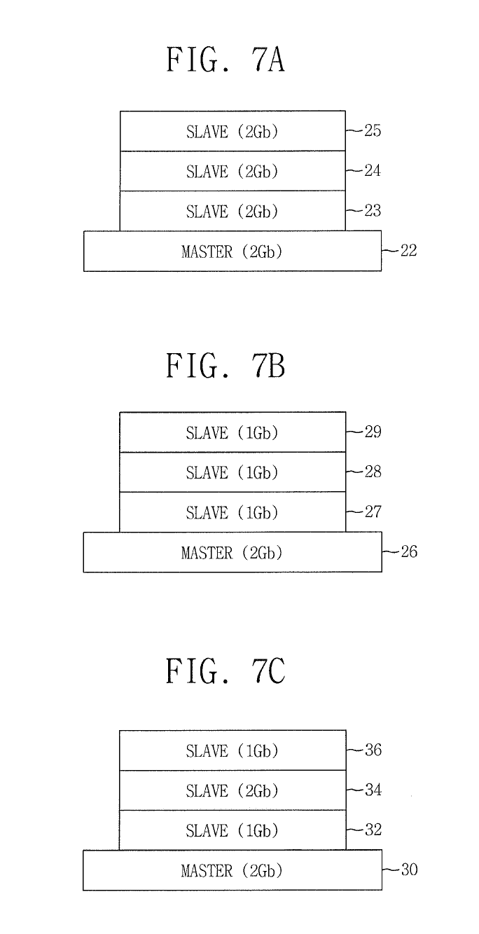

FIGS. 6A-8D are cross-sectional views illustrating the stacked memory device included in the memory system shown in FIGS. 1 and 4, according to exemplary embodiments.

Each of FIG. 6A and FIG. 6B illustrates a stacked memory device having a master and one slave stacked on the master. FIG. 6A shows a stacked memory device having a total capacity of 4 GB, in which the master 12 has a capacity of 2 GB and the slave 13 has a capacity of 2 GB. FIG. 6B shows a stacked memory device having a total capacity of 3 GB, in which the master 14 has a capacity of 2 GB and the slave 15 has a capacity of 1 GB.

Referring to FIG. 6A, both a semiconductor memory chip used as the master 12 and a semiconductor memory chip used as the slave 13 do not include a defective cell. As a result, each of the master 12 and the slave 13 has a full capacity of 2 GB, respectively. Referring to FIG. 6B, a semiconductor chip used as the master 14 does not include a defective cell, and a semiconductor memory chip used as the slave 15 includes a defective cell. As a result, the master has a full capacity of 2 GB and the slave 15 has a capacity of 1 GB, which is half of the capacity of the semiconductor memory chip used as the master 14.

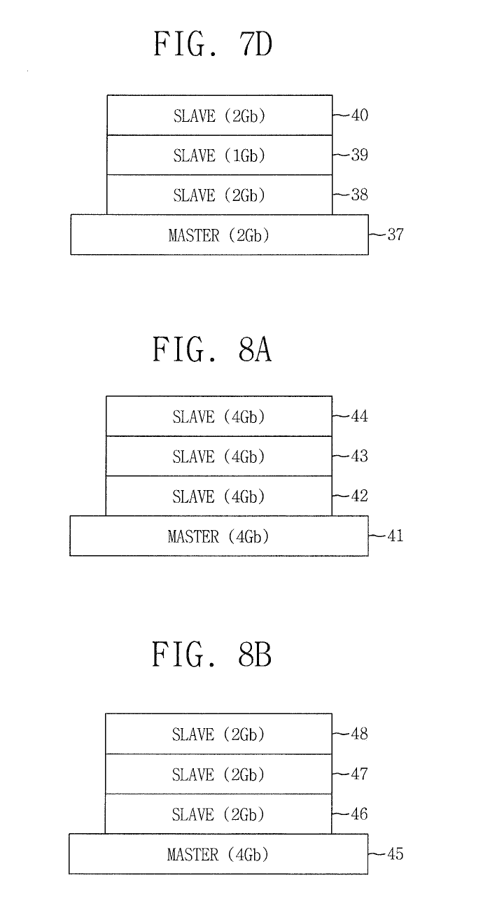

Each of FIG. 7A-7D illustrates a stacked memory device having a master and three slaves stacked on the master. The stacked memory device of FIG. 7A includes a master 22 and three slaves 23, 24 and 25 stacked on the master 22. The stacked memory device of FIG. 7B includes a master 26 and three slaves 27, 28 and 29 stacked on the master 26. The stacked memory device of FIG. 7C includes a master 30 and three slaves 32, 34 and 36 stacked on the master 30. The stacked memory device of FIG. 7D includes a master 37 and three slaves 38, 39 and 40 stacked on the master 37.

The stacked memory device of FIG. 7A has a total capacity of 8 GB, in which the master 22 has a capacity of 2 GB and each of the slaves 23, 24 and 25 has a capacity of 2 GB. The stacked memory device of FIG. 7B has a total capacity of 5 GB, in which the master 26 has a capacity of 2 GB and each of the slaves 27, 28 and 29 has a capacity of 1 GB. The stacked memory device of FIG. 7C has a total capacity of 6 GB, in which the master 30 has a capacity of 2 GB and the slaves 32, 34 and 36 have a capacity of 1 GB, 2 GB and 1 GB, respectively. The stacked memory device of FIG. 7D has a total capacity of 7 GB, in which the master 37 has a capacity of 2 GB and the slaves 38, 39 and 40 have a capacity of 2 GB, 1 GB and 2 GB, respectively.

Referring to FIG. 7A, a semiconductor memory chip used as the master 22 and semiconductor memory chips used as slaves 23, 24 and 25 do not include a defective cell. As a result, each of the master 22 and the slaves 23, 24 and 25 has a full capacity of 2 GB. Referring to FIG. 7B, a semiconductor memory chip used as the master 26 does not include a defective cell, and semiconductor memory chips used as slaves 27, 28 and 29 include a defective cell. As a result, the master has a full capacity of 2 GB, and each of the slaves 27, 28 and 29 has a capacity of 1 GB (e.g., half the capacity of the master 26). Referring to FIG. 7C, a semiconductor memory chip used as the master 30 does not include a defective cell, a semiconductor memory chip used as a slave 34 does not include a defective cell, and semiconductor memory chips used as slaves 32 and 36 include a defective cell. As a result, each of the master 30 and the slave 34 has a full capacity of 2 GB, and each of the slaves 32 and 36 has a capacity of 1 GB (e.g., half the capacity of the master 30). Referring to FIG. 7D, a semiconductor memory chip used as the master 37 does not include a defective cell, each of the semiconductor memory chips used as slaves 38 and 40 does not include a defective cell, and a semiconductor memory chip used as a slave 39 includes a defective cell. As a result, each of the master 37 and the slaves 38 and 40 has a full capacity of 2 GB, and the slave 39 has a capacity of 1 GB (e.g., half the capacity of the master 37).

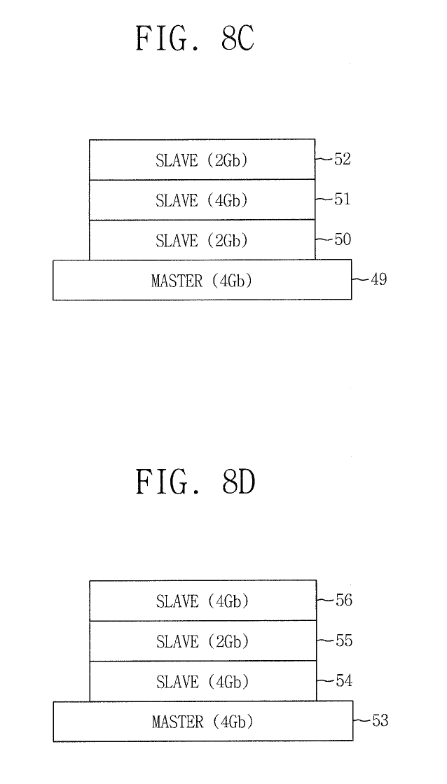

Each of FIG. 8A to FIG. 8D illustrates a stacked memory device having a master and three slaves stacked on the master. The stacked memory device of FIG. 8A includes a master 41 and three slaves 42, 43 and 44 stacked on the master 41. The stacked memory device of FIG. 8B includes a master 45 and three slaves 46, 47 and 48 stacked on the master 45. The stacked memory device of FIG. 8C includes a master 49 and three slaves 50, 51 and 52 stacked on the master 49. The stacked memory device of FIG. 8D includes a master 53 and three slaves 54, 55 and 56 stacked on the master 53.

The stacked memory device of FIG. 8A has a total capacity of 16 GB, in which the master 41 has a capacity of 4 GB and each of the slaves 42, 43 and 44 has a capacity of 4 GB. The stacked memory device of FIG. 8B has a total capacity of 10 GB, in which the master 45 has a capacity of 4 GB and each of the slaves 46, 47 and 48 has a capacity of 2 GB. The stacked memory device of FIG. 8C has a total capacity of 12 GB, in which the master 49 has a capacity of 4 GB and the slaves 50, 51 and 52 have a capacity of 2 GB, 4 GB and 2 GB, respectively. The stacked memory device of FIG. 8D has a total capacity of 14 GB, in which the master 53 has a capacity of 4 GB and the slaves 54, 55 and 56 have a capacity of 4 GB, 2 GB and 4 GB, respectively.

Referring to FIG. 8A, a semiconductor memory chip used as the master 41 and semiconductor memory chips used as slaves 42, 43 and 44 do not include a defective cell. As a result, each of the master 41 and the slaves 42, 43 and 44 has a full capacity of 4 GB. Referring to FIG. 8B, a semiconductor memory chip used as the master 45 does not include a defective cell, and semiconductor memory chips used as slaves 46, 47 and 48 include a defective cell. As a result, the master has a full capacity of 4 GB, and each of the slaves 46, 47 and 48 has a capacity of 2 GB (e.g., half the capacity of the master 45). Referring to FIG. 8C, a semiconductor memory chip used as the master 49 does not include a defective cell, a semiconductor memory chip used as a slave 51 does not include a defective cell, and semiconductor memory chips used as slaves 50 and 52 include a defective cell. As a result, each of the master 49 and the slave 51 has a full capacity of 4 GB, and each of the slaves 50 and 52 has a capacity of 2 GB (e.g., half the capacity of the master 49). Referring to FIG. 8D, a semiconductor memory chip used as the master 53 does not include a defective cell, each of the semiconductor memory chips used as slaves 54 and 56 does not include a defective cell, and a semiconductor memory chip used as a slave 55 includes a defective cell. As a result, each of the master 53 and the slaves 54 and 56 has a full capacity of 4 GB, and the slave 55 has a capacity of 2 GB (e.g., half the capacity of the master 53).

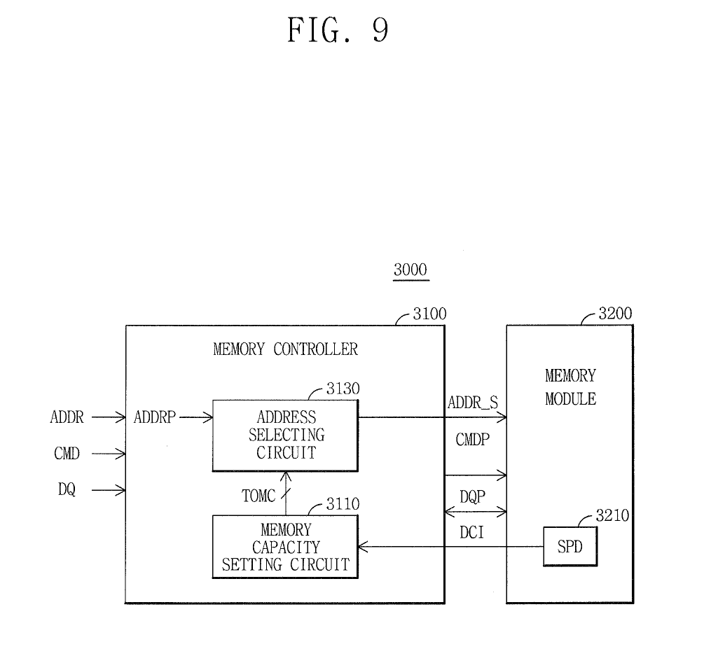

FIG. 9 is a block diagram illustrating a memory system 3000, according to an exemplary embodiment.

Referring to FIG. 9, the memory system 3000 includes a memory controller 3100 and a memory module 3200. The memory module 3200 includes semiconductor memory devices and a serial presence detector (SPD) 3210.

The SPD stores information relating to the memory module such as, for example, the mounting status, operating speed and operating time of memory devices. The information relating to the memory module is provided to the memory controller 3100 in response to a request from the memory controller 3100. Further, the SPD of the memory module 3200 stores a defective cell information signal DCI, and provides the defective cell information signal DCI to the memory controller 3100 in response to a request from the memory controller 3100. The SPD of the memory module 3200 may include a non-volatile memory device such as, for example, a flash memory device.

The memory controller 3100 performs signal processing such as, for example, channel-skew compensation and buffering with respect to a first address signal ADDR, a first command signal CMD and a first data signal DQ. Further, the memory controller 3100 generates a second address signal ADDRP, a second command signal CMDP and a second data signal DQP.

The memory controller 3100 receives the defective cell information signal DCI, sets a valid memory capacity of each memory chip in the memory module 3200 based on the defective cell information signal DCI, and generates a valid memory capacity signal TOMC. The memory controller 3100 generates a selection address signal ADDR_S based on the second address signal ADDRP and the valid memory capacity signal TOMC. When generating the selection address signal ADDR_S, the memory controller 3100 disables the address signals corresponding to memory blocks having defective cells. The memory controller 3100 provides the selection address signal ADDR_S, the second command signal CMDP and the second data signal DQP to the memory module 3200, and receives data from the memory module 3200.

A memory cell array in the memory module 3200 is activated based on the selection address signal ADDR_S and the second command signal CMDP. Since addresses corresponding to memory blocks having defective cells are disabled when the selection address signal ADDR_S is generated, memory blocks in the memory cell array having defective cells are not activated.

The memory controller 3100 includes a memory capacity setting circuit 3110 and an address selecting circuit 3130. The memory capacity setting circuit 3110 sets the valid memory capacity of each memory chip in the memory module 3200 based on the defective cell information signal DCI, and generates the valid memory capacity signal TOMC. The address selecting circuit 3130 disables the address signal corresponding to a memory block that includes a defective cell and generates the selection address signal ADDR_S in response to the valid memory capacity signal TOMC.

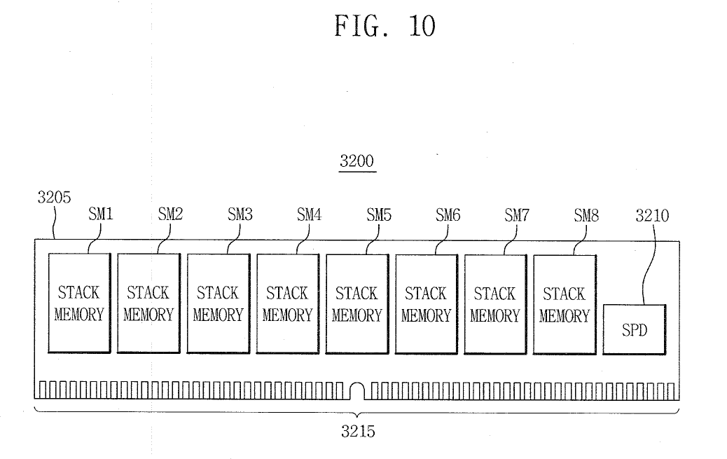

FIG. 10 is a plan view illustrating a memory module 3200 included in the memory system 3200 of FIG. 9, according to an exemplary embodiment.

Referring to FIG. 10, the memory module 3200 includes stacked memory devices SM1 to SM8 and an SPD 3210 mounted on a printed circuit board (PCB) 3205. Although FIG. 10 shows eight stacked memory devices SM1 to SM8 mounted on the upper side of the PCB 3205, the present inventive concept is not limited thereto. For example, the memory module 3200 may include stacked memory devices mounted on the bottom side of the PCB 3205.

The stacked memory devices SM1 to SM8 may have the same structure as the stacked memory device shown in FIG. 2, according to an exemplary embodiment. As described above, information relating to the memory module such as, for example, the mounting status, operating speed and operating time of memory devices is stored in the SPD. The information relating to the memory module is provided to the memory controller 3100 in response to a request from the memory controller 3100.

A plurality of contacts 3215 arranged on the PCB 3205 allow signals to be transmitted and received between the memory module 3200 and an external device. In the memory module 3200 shown in FIG. 10, buses through which signals are transmitted are omitted.

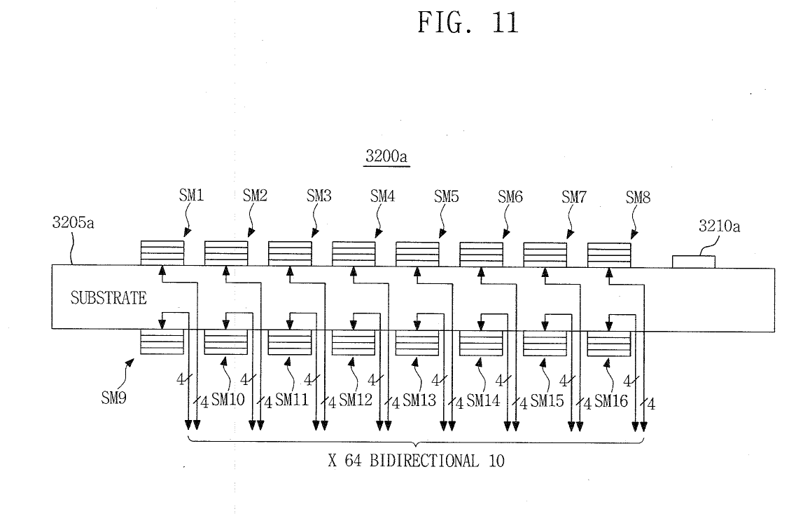

FIG. 11 is a cross-sectional view illustrating a memory module 3200a, according to an exemplary embodiment.

Referring to FIG. 11, the memory module 3200a includes a plurality of stacked memory devices on both sides of a substrate 3205a. The upper side of the memory module 3200a includes stacked memory devices SM1 to SM8 and an SPD 3210a, and the bottom side of the memory module 3200a includes stacked memory devices SM9 to SM16. The memory module 3200a includes an X64 input/output data structure. 4-bit data is simultaneously input or output to and from the stacked memory devices included in the memory module 3200a.

In FIG. 11, the SPD 3210a is mounted on the upper side of the memory module 3200a, however the present inventive concept is not limited thereto. For example, the SPD 3210a may be mounted on the bottom side of the memory module 3200a or on both sides of the memory module 3200a.

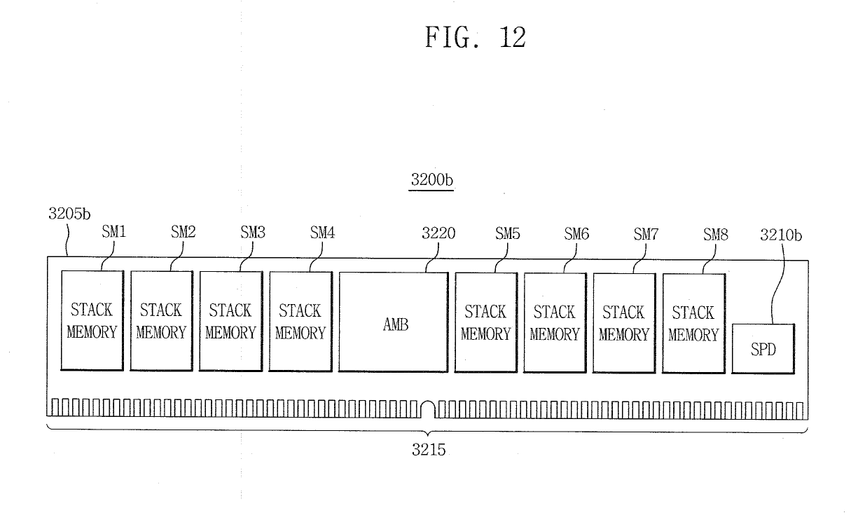

FIG. 12 is a plan view illustrating a memory module 3200 included in the memory system 3000 of FIG. 9, according to an exemplary embodiment. FIG. 12 illustrates a fully-buffered dual-in-line memory module (FBDIMM) including an advanced memory buffer (AMB) that buffers data transmitted to and from stacked memory devices.

Referring to FIG. 12, the memory module 3200b includes stacked memory devices SM1 to SM8, an AMB 3220 and an SPD 3210b. In FIG. 12, eight stacked memory devices SM1 to SM8 are mounted on the upper side of the PCB 3205b, however, the present inventive concept is not limited thereto. For example, the memory module 3200b may include eight stacked memory devices mounted on the bottom side of the PCB 3205b.

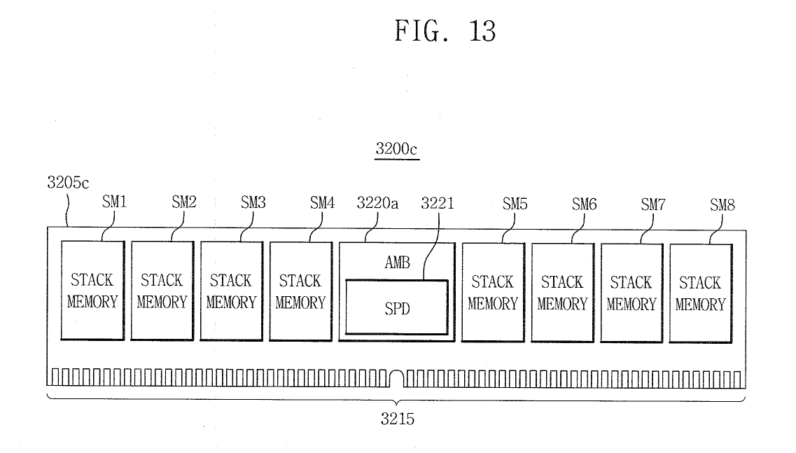

FIG. 13 is a plan view illustrating a memory module 3200 included in the memory system 3000 of FIG. 9, according to an exemplary embodiment. FIG. 13 illustrates an FBDIMM including an AMB that buffers data transmitted to and from stacked memory devices.

Referring to FIG. 13, the memory module 3200c includes stacked memory devices SM1 to SM8 and an AMB 3220a arranged on the PCB 3205c. In FIG. 13, eight stacked memory devices SM1 to SM8 are mounted on the upper side of the PCB 3205c, however, the present inventive concept is not limited thereto. For example, the memory module 3200c may include eight stacked memory devices mounted on the bottom side of the PCB 3205c. The memory module 3200c of FIG. 13 may include the SPD 3221 in the AMB 3220a.

As described above, and referring to FIGS. 9-13, the memory system 3000 may adjust the memory capacity of each semiconductor memory chip included in each of the stacked memory devices in the memory module 3200.

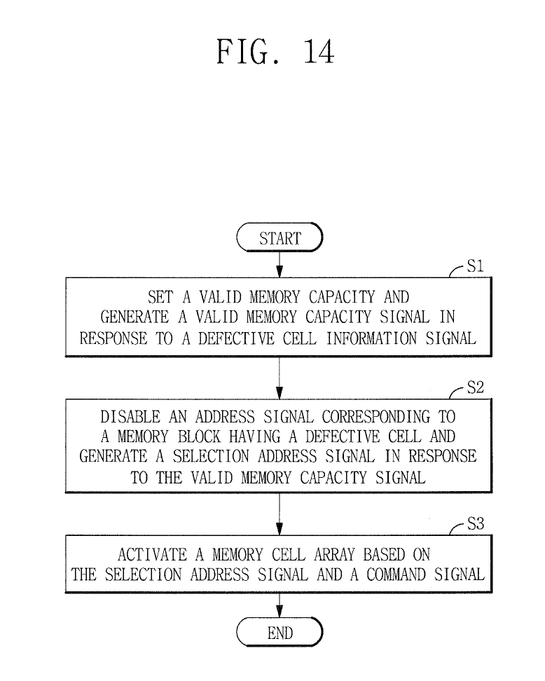

FIG. 14 is a flowchart illustrating a method of controlling a memory system, according to an exemplary embodiment.

Referring to FIG. 14, the memory system sets a valid memory capacity and generates a valid memory capacity signal in response to a defective cell information signal at block S1. The memory system disables an address signal corresponding to a memory block having a defective cell and generates a selection address signal based on the valid memory capacity signal at block S2. The memory system activates a memory cell array based on the selection address signal and a command signal at block S3.

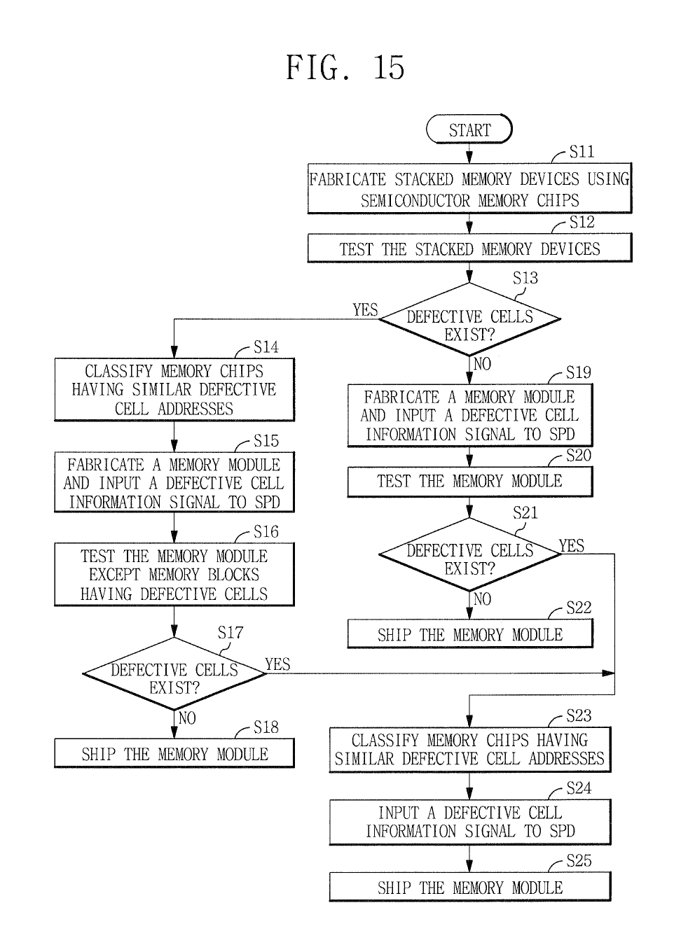

FIG. 15 is a flowchart illustrating a process for manufacturing and shipping a memory module including a stacked memory device, according to an exemplary embodiment.

Referring to FIG. 15, stacked memory devices using semiconductor memory chips are fabricated at block S11. The stacked memory devices are tested at block S12. At block S13, it is determined whether defective cells exist in the stacked memory devices. If defective cells exist in the stacked memory devices, memory chips having similar defective cell addresses are classified at block S14. A memory module is fabricated using stacked memory devices and a defective cell information signal is input to the SPD at block S15. In response to the defective cell information signal stored in the SPD, all memory blocks in the memory module except the memory blocks having defective cells are tested at block S16. At block S17, it is determined whether defective cells exist in the stacked memory devices included in the memory module. If no defective cells exist, the memory module is shipped at block S18. At block S19, a memory module is fabricated using stacked memory devices and a defective cell information signal is input to the SPD if it is determined that no defective cells exist at block S13. The memory module is tested in response to the defective cell information signal stored in the SPD at block S20. At block S21, it is determined whether defective cells exist in the stacked memory devices included in the memory module. If no defective cells exist, the memory module is shipped at block S22. If defective cells exist, memory chips having similar defective cell addresses are classified at block S23. A defective cell information signal is input to the SPD at block S24. The memory module is shipped at block S25.

In the above exemplary embodiments, a memory system including stacked memory devices and a memory system including a memory module comprising stacked memory devices are described. However, the present inventive concept is not limited thereto. For example, exemplary embodiments of the present inventive concept may be applied to other types of memory devices including, for example, a dynamic random access memory (DRAM), a memory module or a memory system having the memory device.

As described in the above exemplary embodiments, a semiconductor memory chip in a stacked memory device having a defective cell may utilize half of the valid memory capacity of a semiconductor memory chip not having a defective cell. Therefore, a stacked memory device including a semiconductor memory chip having a defective cell may have various memory capacities, depending on the number of semiconductor memory chips and the number of defective cells in the stacked memory device.

The stacked memory device and the memory system including the stacked memory device disables access to memory blocks having defective memory cells, allowing semiconductor memory chips having defective cells to be shipped as functional products, rather than being discarded during production.

According to exemplary embodiments, semiconductor memory chips included in the stacked memory device and the memory system may have various valid memory capacities, depending on the number of semiconductor memory chips and the number of defective cells present in the stacked memory device. Further, a high production yield may be achieved as a result of using semiconductor memory chips with defective cells.

While the present inventive concept has been particularly shown and described with reference to exemplary embodiments thereof, it will be understood by those of ordinary skill in the art that various changes in form and detail may be made therein without departing from the spirit and scope of the present inventive concept as defined by the following claims.

What is claimed is:

1. A memory controller, comprising:
a memory capacity setting circuit configured to set a valid memory capacity of a memory device based on a defective cell information signal, and generate a valid memory capacity signal based on the valid memory capacity; and
an address selecting circuit configured to disable an address signal corresponding to a memory block having a defective cell, and generate a selection address signal based on the valid memory capacity signal and the disabled address signal,
wherein a non-defective cell in a memory cell array is activated based on the selection address signal and a command signal.

2. The memory controller of claim 1, wherein the valid memory capacity includes one of a first capacity corresponding to a full capacity of the memory device or a second capacity corresponding to half of the full capacity of the memory device.

3. The memory controller of claim 2, wherein a capacity of the memory device is set to the first capacity upon determining that a defective cell is not included in the memory device, and set to the second capacity upon determining that the defective cell is included in the memory device.

4. The memory controller of claim 1, wherein a memory block having a defective cell in the memory cell array is not activated during a refresh mode of the memory device.

5. The memory controller of claim 1, wherein a non-volatile memory device is configured to store the defective cell information signal and provide the defective cell information signal to the memory controller in response to a request from the memory controller.

6. The memory controller of claim 1, wherein the memory device comprises an internal register configured to store the defective cell information signal, and disable the address signal corresponding to the memory block having the defective cell, based on the defective cell information signal.

7. The memory controller of claim 1, wherein the memory device comprises a stacked memory device having a plurality of stacked semiconductor memory chips.

8. The memory controller of claim 7, wherein one of the plurality of stacked semiconductor memory chips has a defective cell, and a capacity of the one of the plurality of stacked semiconductor chips is set to half of a capacity of a stacked semiconductor memory chip not having the defective cell.

9. The memory controller of claim 7, wherein a most significant bit (MSB) of a row address corresponding to a semiconductor memory chip having a defective cell is not used in the selection address signal.

10. A stacked memory device, comprising:
at least one master chip configured to interface with an exterior of a memory device, and disable an address signal corresponding to a memory block that includes a defective cell; and
at least one slave chip stacked on the master chip, and electrically coupled to the master chip via a through-electrode.

11. The stacked memory device of claim 10, wherein the stacked memory device receives a defective cell information signal from a memory controller.

12. The stacked memory device of claim 11, wherein the stacked memory device is configured to disable the address signal corresponding to the memory block that includes the defective cell upon the memory controller setting a valid memory capacity of the stacked memory device, wherein the memory controller sets the valid memory capacity based on the defective cell information signal.

13. The stacked memory device of claim 12, wherein the valid memory capacity includes one of a first capacity corresponding to a full capacity of the stacked memory device or a second capacity corresponding to half of the full capacity of the stacked memory device.

14. The stacked memory device of claim 13, wherein a capacity of a first slave chip is set to the first capacity upon determining that the first slave chip does not include a defective cell, and a capacity of a second slave chip is set to the second capacity upon determining that the second slave chip includes the defective cell.

15. A memory system, comprising:
a memory controller, comprising:
a memory capacity setting circuit configured to set a valid memory capacity of a memory device based on a defective cell information signal, and generate a valid memory capacity signal based on the valid memory capacity, and
an address selecting circuit configured to disable an address signal corresponding to a memory block having a defective cell, and generate a selection address signal based on the valid memory capacity signal and the disabled address signal; and
a memory module comprising a plurality of memory devices, wherein each of the plurality of memory devices is configured to activate a non-defective cell in a memory cell array in each of the plurality of memory devices based on the selection address signal and a command signal.

16. The memory system of claim 15, wherein the memory module further comprises a serial presence detector (SPD) configured to store the defective cell information signal and provide the defective cell information signal to the memory controller in response to a request from the memory controller.

17. The memory system of claim 16, wherein the SPD is configured to store information relating to the memory module.

18. The memory system of claim 17, wherein the information stored in the SPD includes a mounting status, an operating speed, or an operating time of a memory device.

19. The memory system of claim 15, wherein the valid memory capacity includes one of a first capacity corresponding to a full capacity of the memory device or a second capacity corresponding to half of the full capacity of the memory device.

20. A method of controlling a memory device, comprising:
setting a valid memory capacity of the memory device based on a defective cell information signal;
generating a valid memory capacity signal based on the valid memory capacity;
disabling an address signal corresponding to a memory block having a defective cell;
generating a selection address signal based on the valid memory capacity signal and the disabled address signal; and
activating a non-defective cell in a memory cell array based on the selection address signal and a command signal.
